(19) United States
(12) Patent Application Publication
(10) Pub. No.: US 2015/0325950 A1
(43) Pub. Date: Nov. 12, 2015

(54) LEVER TYPE CONNECTOR

(71) Applicant: Yazaki Corporation, Tokyo (JP)

(72) Inventor: Jun KAMIYA, Toyota-shi (JP)

(73) Assignee: YAZAKI CORPORATION, Tokyo (JP)

(21) Appl. No.: 14/403,758

(22) PCT Filed: May 31, 2013
(86) PCT No.: PCT/JP2013/065763

§ 371 Date: Nov. 25, 2014

(30) Foreign Application Priority Data
Jun. 15, 2012 (JP) 2012-136045

(51) Int. Cl. H01R 13/629; H01R 13/502

(52) U.S. Cl. CPC H01R 13/62933; H01R 13/502

(57) ABSTRACT

A fitting operation lever, provided for fitting connector housings with each other, becomes detachable from the connector housings. The fitting operation lever includes boss pivot supporting grooves with which first lever engaging shafts of the first connector housing are engaged to pivot the fitting operation lever, boss leading grooves which guide second lever engaging shafts of the second connector housing to fitting initial positions, and cam grooves which communicate with the boss leading grooves. The connector housings are closely fitted with each other through the cam grooves in accordance with pivoting of the fitting operation lever. The cam grooves become disengaged from the second lever engaging shafts when the fitting operation lever is further pivoted.

### TECHNICAL FIELD

The present invention relates to a lever type connector.

### BACKGROUND ART

FIG. 14 shows an example of a lever type connector.

A lever type connector 100 which is disclosed in Patent Literature 1 includes a first connector housing 110, a second connector housing 120 which is fitted and connected with the first connector housing 110, and a fitting operation lever 130 which is pivotably mounted to the first connector housing 110.

The second connector housing 120 has an outer box wall part (hood part) 121 into which the first connector housing 110 is inserted.

The fitting operation lever 130 is a member by which an operating force when the operations of fitting/detaching the first connector housing 110 into/from the second connector housing 120 are performed can be reduced, and is pivotably mounted to boss parts 111 which are protruded from the outer side surfaces of the first connector housing 110.

As shown in the figure, the fitting operation lever 130 includes a pair of lever bodies 131 which are arranged to be opposite to each other so that a pair of outer side surfaces of the first connector housing 110 are sandwiched, a joint member 132 that connects the pair of lever bodies 131 at one end side, pivot fulcrum holes 133 which are formed in the lever bodies 131 and are pivotably engaged with the boss parts 111 on the outer side surfaces of the first connector housing 110, and application point protruding parts 134 which are engaged with lever retaining holes 122 which are formed at the outer side surfaces of the outer box wall part 121 when a fitting that the first connector housing 110 and the second connector housing 120 are aligned to a fitting start position begins.

In the case of the illustrated example, the joint member 132 also serves as an effort point part which receives the operating force when the lever bodies 131 are pivoted around the boss parts 111.

For the lever type connector 100 of the Patent Literature 1, the first connector housing 110 is fitted and connected with the second connector housing 120 with the following steps.

First, as shown in the figure, the first connector housing 110 is pivotably attached to the fitting operation lever 130. Then, as shown by an arrow X1 in the figure, the front end of the first connector housing 110 is inserted into the outer box wall part 121 of the second connector housing 120, the first connector housing 110 and the second connector housing 120 are aligned at the fitting start positions, and the application point protruding parts 134 of the fitting-operation lever 130 are engaged with the lever retaining holes 122 of the second connector housing 120.

Then, the joint member 132 of the fitting operation lever 130 is pressed down, and as shown by an arrow R1 in the figure, the fitting operation lever 130 is pivoted. The second connector housing 120 is drawn to the side of the first connector housing 110 with the pivoting movement of the fitting-operation lever 130, and the fitting of the connector housings with each other is completed.

When the connector housings fitted with each other are to be detached, the joint member 132 is pivoted in a direction opposite to the direction shown by the arrow R1 in the figure so that the connector housings are detached from each other.

A lever type connector disclosed in Patent Literature 2 is so constructed that the first connector housing and the second connector housing, which are aligned to a fitting start positions, are fitted and connected with the fitting operation lever (refer to as a slide 14 in Patent Literature 2) to which the first connector housing is inserted and installed.

The fitting operation lever in Patent Literature 2 is inserted into the first connector housing in a direction perpendicular to the direction in which the connector housings are fitted with each other. The fitting operation lever is formed with guiding grooves in a slant state so that lever engaging shafts protruded from the outer side surfaces of the second connector housing are slidable, and with the slant of the guiding grooves, the lever engaging shafts are guided in a direction the connector housings are fitted with each other to make the connector housings to be fitted with each other.

### CITATION LIST

### Patent literature

Patent Literature 1: Japanese Patent No. 3442661

Patent Literature 2: JP-A-7-135046

### SUMMARY OF INVENTION

### Technical Problem

However, in the case of the lever type connector of Patent Literature 1 or Patent Literature 2, the fitting operation lever cannot be removed from the first connector housing when the connector housings are fitted with each other.

Therefore, in the case of the lever type connector of Patent Literature 1 or Patent Literature 2, even when the connector housings are actually used after the connector housings are fitted and connected with each other, the weight of the fitting operation lever is added so that the weight of the connector is increased.

In the case of the lever type connector of Patent Literature 1 or Patent Literature 2, the lever type connector must be accompanied by a fitting operation lever, and there is a problem that the cost is increased because of the increase of the component number.

One non-limited object of the present invention is to solve the above problems and provide a lever type connector which can reduce the cost by reducing the number of components and reduce the weight in use.

### Solution to Problem

The above-mentioned object of the invention may be achieved by the following configurations.

(1) A lever type connector, including:

a first connector housing;

a second connector housing which is fitted and connected with the first connector housing; and

a fitting operation lever which is mounted to the first connector housing as a lever component to reduce an operating force when the first connector housing is fitted/detached with/from the second connector housing, wherein

the first connector housing includes:

a housing body which includes a plurality of terminal insertion holes;

a pair of first lever engaging shafts which are protruded from a pair of outer side walls of the housing body, respectively; and

a locking part which is provided at a side surface of the housing body and is engaged with the second connector housing to lock a connecting state of the connector housings with each other when the second connector housing is completed to be fitted and connected with the first connector housing,

the second connector housing includes:

an outer box wall part which is fitted with a circumference of the first connector housing;

a pair of second lever engaging shafts which are protruded respectively from a pair of inner side surfaces of the outer box wall part which face the pair of outer side walls of the first connector housing and which are opposed to the first lever engaging shafts with a predetermined separation distance in a direction the connector housings are fitted with each other when the first connector housing and the second connector housing are aligned in fitting start positions; and

a locked part which is engaged with the locking part to lock the connecting state of the connector housings with each other when the second connector housing is completed to be fitted and connected with the first connector housing, and

the fitting operation lever includes:

a pair of lever bodies which are arranged opposite to each other and to be inserted into gaps between the pair of outer side walls of the first connector housing and the pair of inner side surfaces of the outer box wall part, respectively;

boss pivot supporting grooves which are formed respectively at back end inner surfaces of the pair of lever bodies along a first direction perpendicular to the direction the connector housings are fitted with each other, wherein the boss pivot supporting grooves are engaged with the first lever engaging shafts to pivot the fitting operation lever;

boss leading grooves which are formed respectively at lower edges of the outer surfaces of the pair of lever bodies along the direction the connector housings are fitted with each other, wherein the boss leading grooves guide the second lever engaging shafts to fitting initial positions when the first connector housing, with which the fitting operation lever is positioned at a pivoting initial position, and the second connector housing are aligned to the fitting start positions; and

cam grooves which communicate with the boss leading grooves, wherein the cam grooves make a force in the direction the connector housings are fitted with each other act on the second lever engaging shafts which are positioned at the fitting initial positions with the pivoting so that the connector housings are closely fitted with each other when the fitting operation lever is pivoted from the pivoting initial position toward a pivoting completed position, cause the connector housings to complete to be fitted with each other when the fitting operation lever is pivoted to a fitting completed position before the pivoting completed position, and become disengaged from the second lever engaging shafts when the fitting operation lever is pivoted to the pivoting completed position, wherein

when the fitting operation lever is pivoted to the pivoting completed position, the fitting operation lever becomes detachable from the connector housings.

(2) The lever type connector according to the configuration (1), wherein

the first connector housing includes a lever temporary locking part which is provided at a side surface of the housing body to temporarily lock the fitting operation lever which is engaged with the pair of the first lever engaging shafts at the pivoting initial position,

the second connector housing includes an unlocking member, which, releases the temporary locking state of the fitting operation lever with the lever temporary locking part so that the fitting operation lever is pivotable when the first connector housing and the second connector housing are aligned to the fitting start positions, and

the fitting operation lever includes a housing temporary locking part which is engaged with the lever temporary locking part when the pair of lever bodies are pivoted around the first lever engaging shafts which are engaged with the boss pivot supporting grooves as a fulcrum to the pivoting initial position so that the pair of lever bodies are temporarily engaged with the first connector housing at the pivoting initial position.

According to the configuration (1), as operation steps when the connector housings are fitted and connected with each other, first, the fitting operation lever is inserted and mounted to the first connector housing so that the pair of first lever engaging shafts of the first connector housing are engaged with the pair of boss pivot supporting grooves of the fitting operation lever.

Then, the first connector housing in the state that the fitting operation lever is positioned at the pivoting initial position is inserted into the outer box wall part of the second connector housing along the direction the connector housings are fitted with each other so that the first connector housing and the second connector housing are aligned to the fitting start positions.

In the state that the first connector housing and the second connector housing are aligned to the fitting start positions, the pair of second lever engaging shafts of the second connector housing are fitted into the boss leading grooves of the fitting operation lever, and arrive at the fitting initial positions on the boss leading grooves.

Then, from the state that the first connector housing and the second connector housing are aligned to the fitting start positions, the fitting operation lever is pivoted from the pivoting initial position toward the pivoting completed position. With the pivoting of the fitting operation lever, the second lever engaging shafts which are positioned in the fitting initial positions slide in the cam grooves which are formed to communicate with the boss leading grooves, and a force in the direction the connector housings are fitted with each other acts on the second lever engaging shafts from the cam grooves. As a result, the connector housings are closely fitted with each other.

When the fitting operation lever is pivoted to the fitting completed position, the fitting of the connector housings with each other is completed. When the fitting and connecting of the connector housings with each other is completed, the locking part of the first connector housing is engaged with the locked part of the second connector housing, and the connecting state of the connector housings with each other is locked.

When the fitting operation lever is further pivoted, and the fitting operation lever is pivoted to the pivoting completed position, the cam shafts are disengaged from the second lever engaging shafts, and the fitting operation lever becomes detachable from the connector housings.

That is, according to the configuration (1), by the pivoting operation of the fitting operation lever, the connector housings are closely fitted with each other, and after the fitting and connecting of the connector housings with each other is completed, if the fitting operation lever is further pivoted to the pivoting completed position, the fitting operation lever becomes detachable from the connector housings. Therefore, when the connector is in use, the fitting operation lever can be kept detached from the connector housings.

Therefore, when the connector is in use, the weight of the fitting operation lever is not added, and reduction in weight when the connector is in use can be realized.

The fitting operation lever which is detached from the connector housings can be used in the fitting operations of other lever type connectors. Therefore, the component set of a regular lever type connector only includes the first connector housing and the second connector housing, but does not include the fitting operation lever, so that the cost can be reduced by reducing the number of components.

According to the configuration (2), if the pair of first lever engaging shafts of the first connector housing are engaged with the pair of boss pivot supporting grooves of the fitting operation lever so that the fitting operation lever is pivotably connected with the first connector housing, when the fitting operation lever on the first connector housing is aligned to the pivoting initial position, by engaging the housing temporary locking part on the fitting operation lever with the lever temporary locking part on the first connector housing, the fitting operation lever temporarily stops at the pivoting start position.

Therefore, when the first connector housing and the second connector housing are aligned to the fitting start positions, the position of the fitting operation lever will not be unintentionally deviated from the pivoting start position, and the operation of aligning the first connector housing and the second connector housing becomes easy.

When the first connector housing and the second connector housing are aligned to the fitting start positions, the state that the fitting operation lever is temporarily locked with the lever temporary locking part is automatically cancelled by the unlocking member which is equipped on the second connector housing. Therefore, after the first connector housing and the second connector housing are aligned to the fitting start positions, it is not necessary to cancel the temporary locking state of the fitting operation lever, and the pivoting operation of the fitting operation lever can be performed immediately.

That is, according to the configuration (2), special operations are not required to maintain or cancel the state that the fitting operation lever temporarily stops at the pivoting initial position, and the operation of fitting the connector housings with each other can be easily performed.

### Advantageous Effects of Invention

According to the lever type connector of the present invention, because the fitting operation lever can be detached from the connector housings after the fitting of the connector housings with each other is completed, a reduction in weight can be realized in an use state of the connector.

The fitting operation lever which is detached from the connector housings can be used in the fitting operations of other lever type connectors. Therefore, the component set of a regular lever type connector only includes the first connector housing and the second connector housing but does not include the fitting operation lever, so that the cost can be reduced by reducing the number of components.

The present invention has been briefly described above. Further, details of the invention will become more apparent after embodiments of the invention described below (hereinafter referred to as “embodiments”) are read with reference to the accompanying figures.

### BRIEF DESCRIPTION OF DRAWINGS

FIG. 1 is an exploded perspective view of one embodiment of the lever type connector concerning the present invention.

FIG. 2 is a perspective view of a second connector housing shown in FIG. 1 seen from another direction.

FIG. 3 is a side view of a fitting operation lever shown in FIG. 1.

FIG. 4 is a front view of the fitting operation lever shown in FIG. 3.

FIG. 5 is a sectional view of FIG. 4 taken along a line V-V.

FIG. 6 is a perspective view of the fitting operation lever shown in FIG. 1 seen from another direction.

FIG. 7 is a side view which shows a state before a first connector housing with the fitting operation lever temporarily locked is inserted into the second connector housing.

FIG. 8 is a sectional view of FIG. 7 taken along a line VIII-VIII.

FIG. 9 is a side view which shows a state that the first connector housing and the second connector housing are aligned to fitting start positions.

FIG. 10 is a sectional view of FIG. 9 taken along a line X-X.

FIG. 11 is a side view which shows a state that the fitting operation lever is pivoted from a pivoting initial position to the side of a pivoting completed position and the fitting and connecting of the connector housings with each other is completed.

FIG. 12 is a side view which shows a state that the fitting operation lever is pivoted to the pivoting completed position and second lever engaging shafts are disengaged from cam grooves.

FIG. 13 is a side view which shows a state that after the connector housings are fitted and connected with each other, the fitting operation lever is detached from the connector housings.

FIG. 14 is an exploded perspective view of a conventional lever type connector.

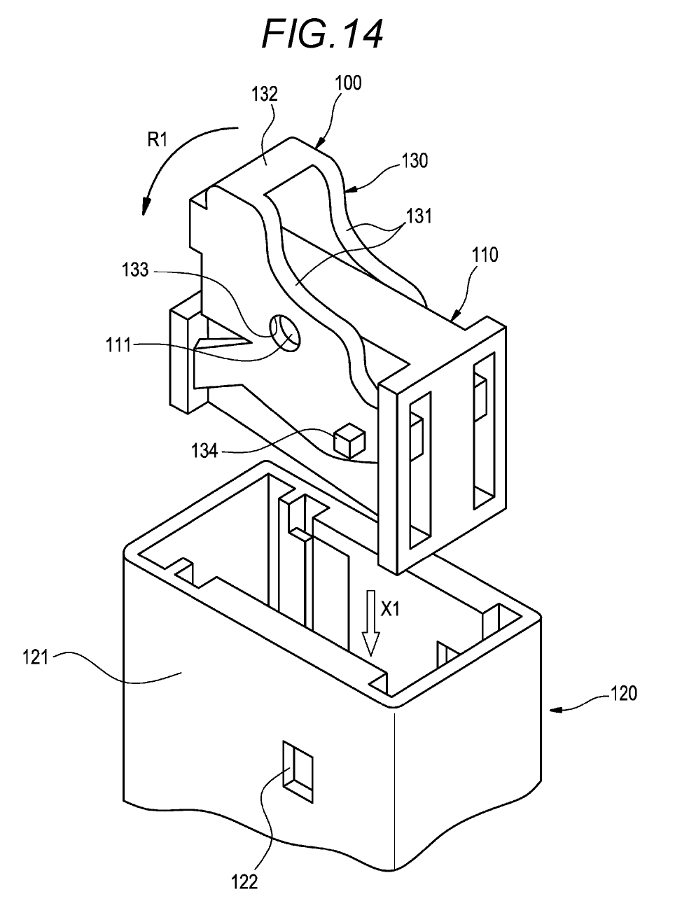

### DESCRIPTION OF EMBODIMENTS

An exemplified embodiment of the lever type connector according to the present invention is described in detail with reference to the figures as follows.

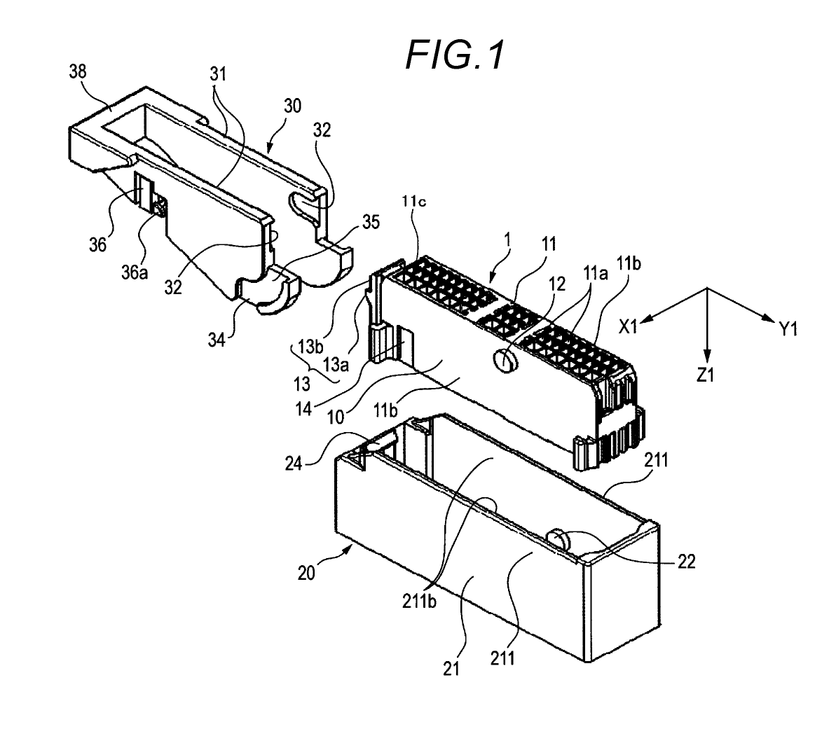

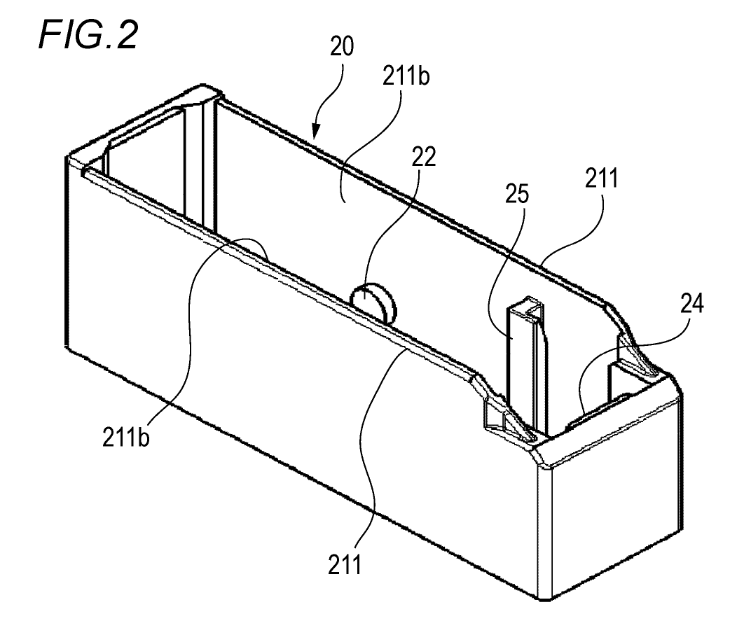

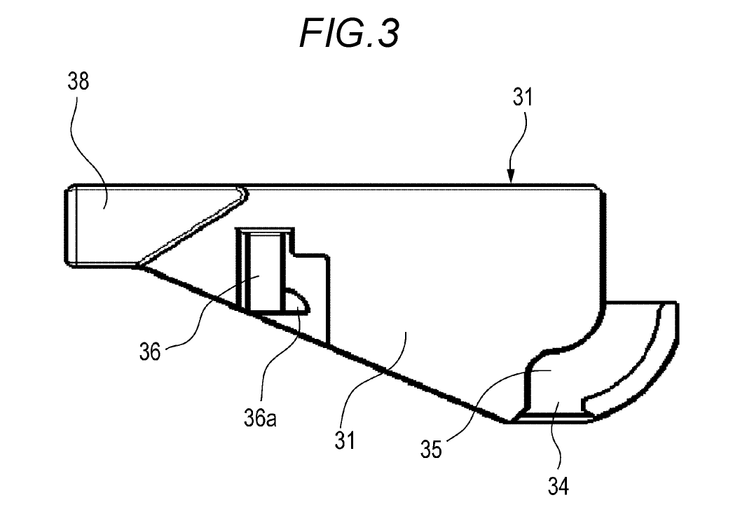

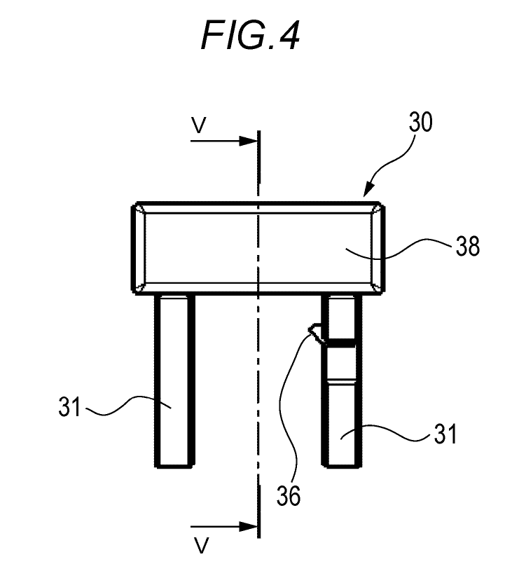

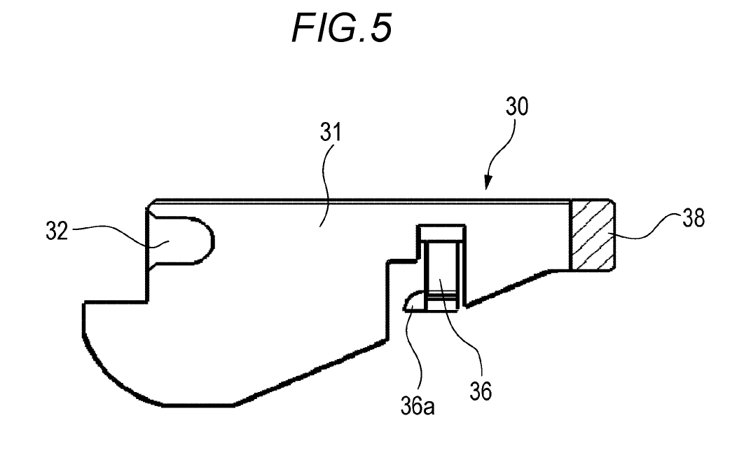

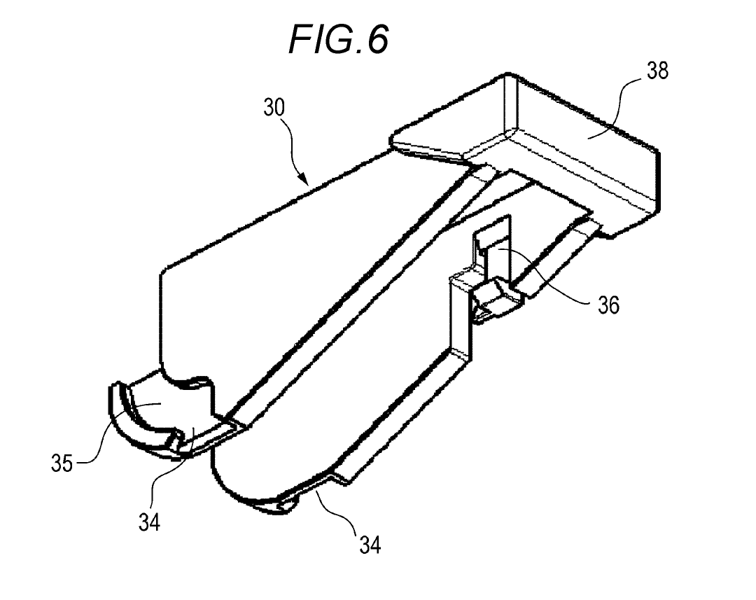

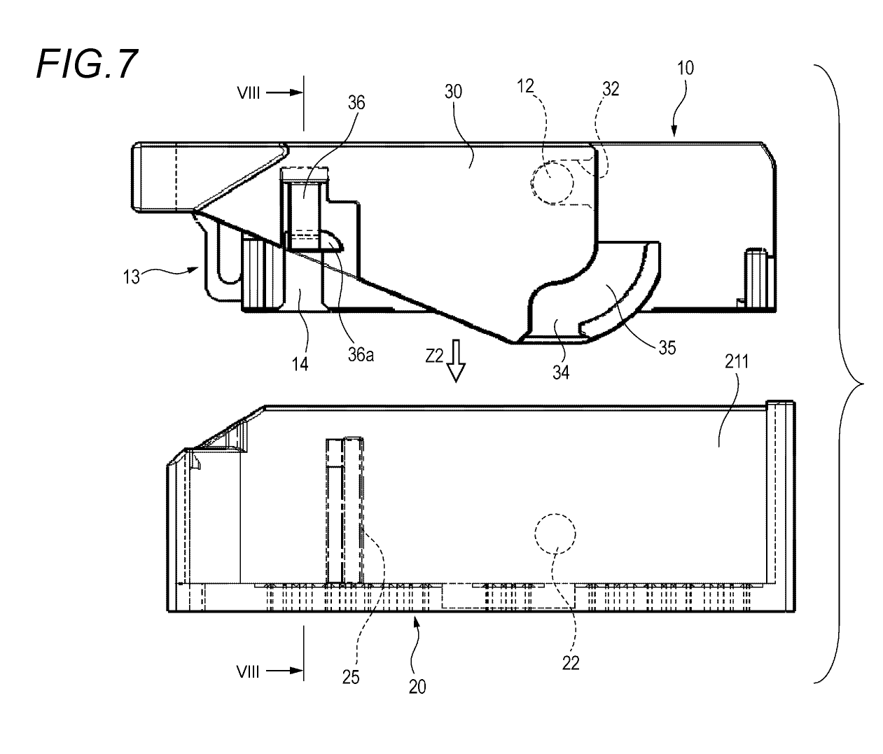

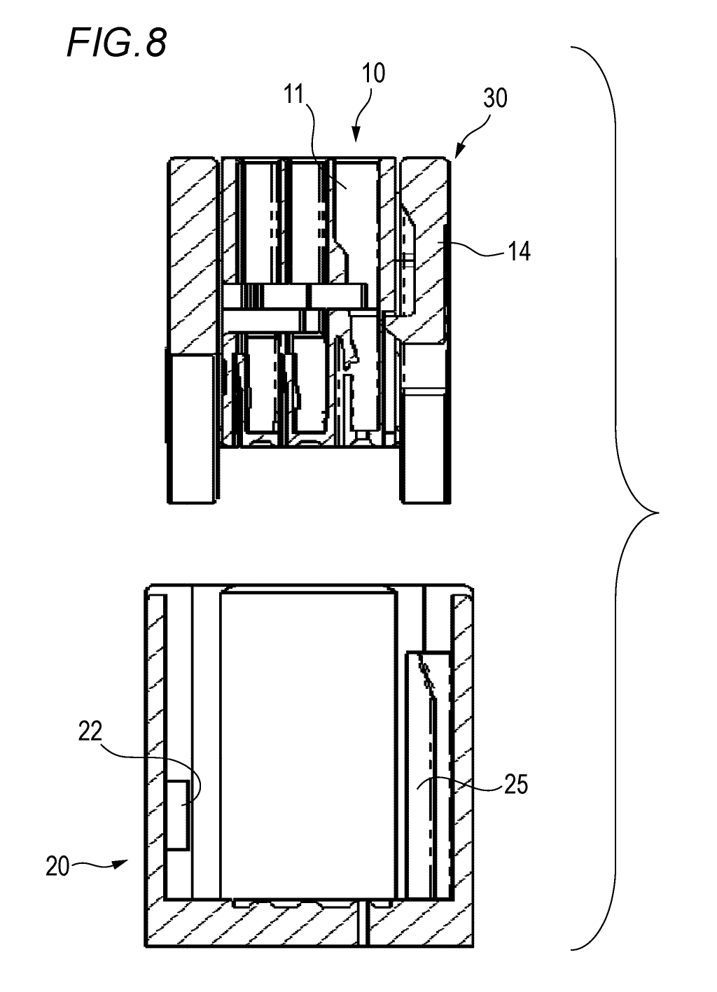

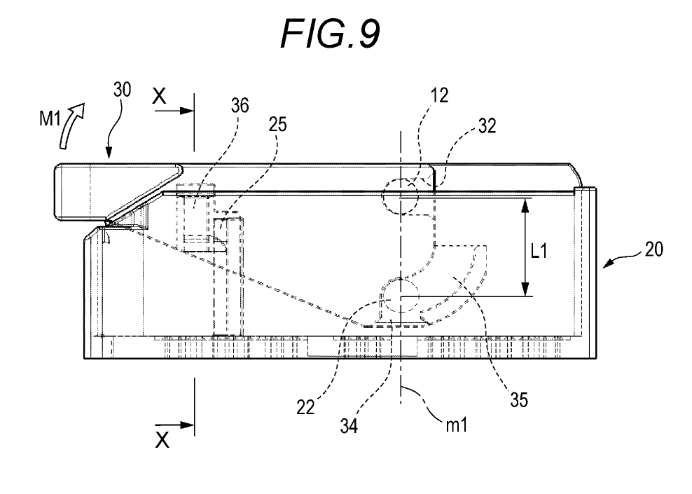

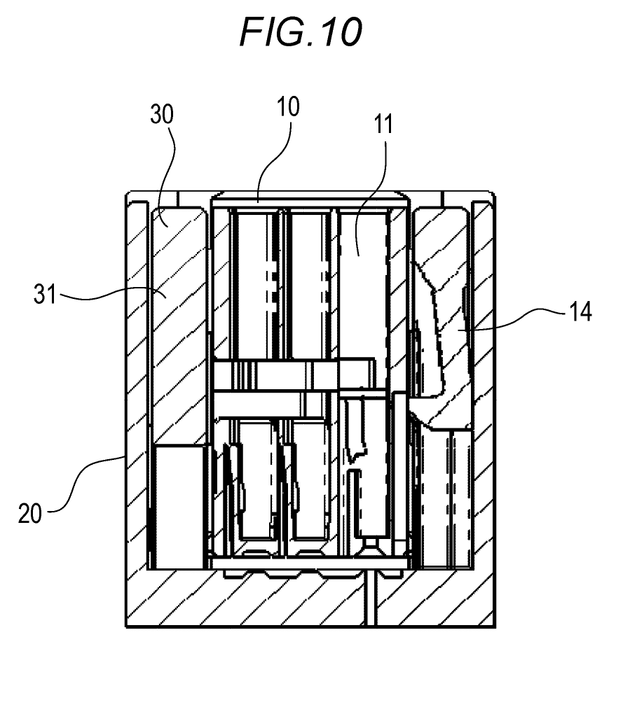

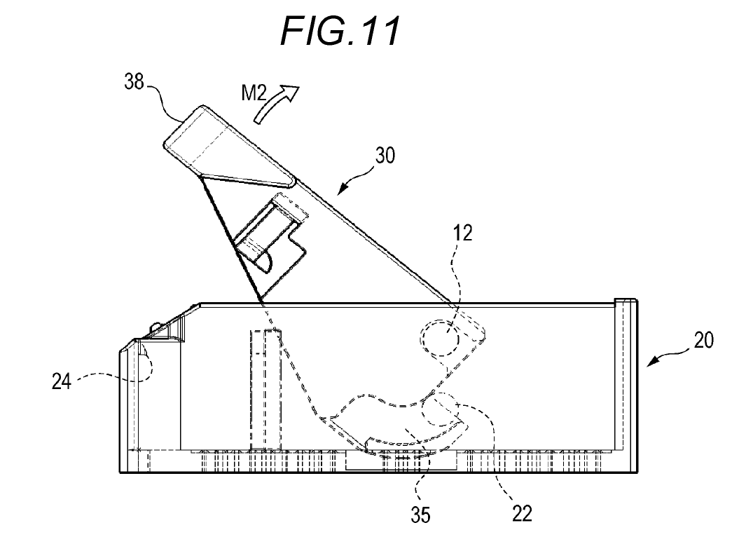

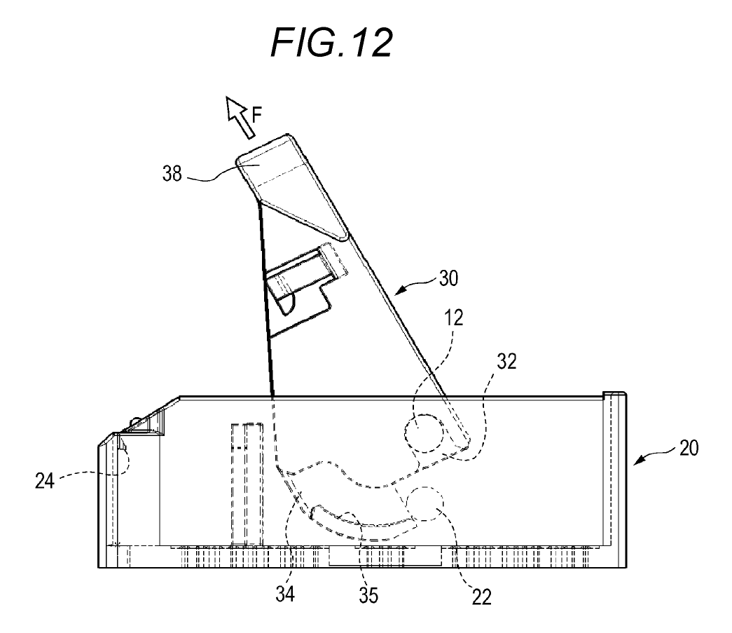

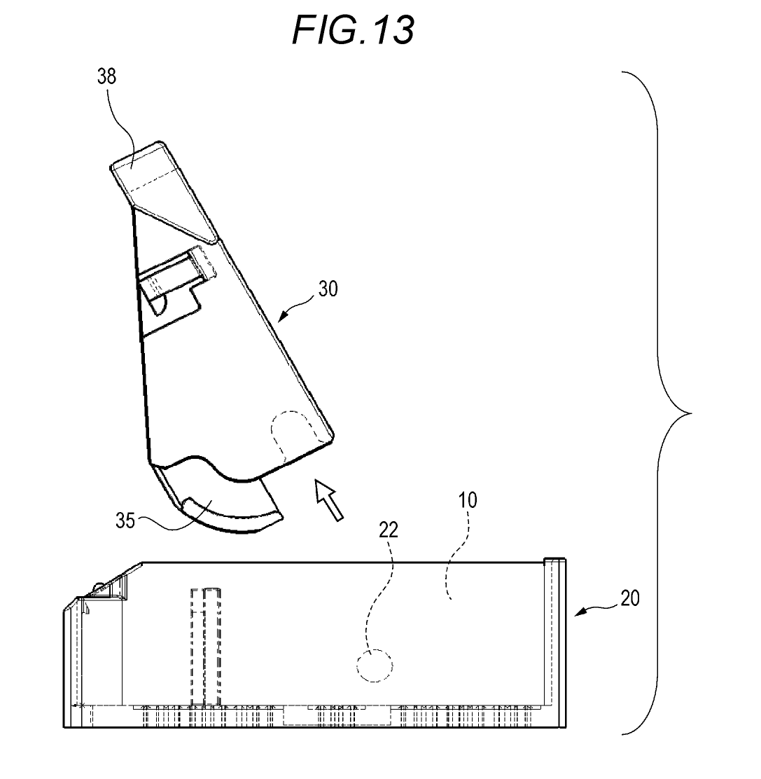

FIGS. 1 to 13 show an embodiment of the lever type connector according to the present invention. FIG. 1 is an exploded perspective view of the lever type connector of the embodiment of the present invention. FIG. 2 is a perspective view of a second connector housing shown in FIG. 1 seen from another direction. FIG. 3 is a side view of a fitting operation lever shown in FIG. 1. FIG. 4 is a front view of the fitting operation lever shown in FIG. 3. FIG. 5 is a sectional view of FIG. 4 taken along a line V-V. FIG. 6 is a perspective view of the fitting operation lever shown in FIG. 1 seen from another direction. FIG. 7 is a side view which shows a state before a first connector housing with the fitting operation lever temporarily locked is inserted into the second connector housing. FIG. 8 is a sectional view of FIG. 7 taken along a line VIII-VIII. FIG. 9 is a side view which shows a state that the first connector housing and the second connector housing are aligned to fitting start positions. FIG. 10 is a sectional view of FIG. 9 taken along a line X-X. FIG. 11 is a side view which shows a state that the fitting operation lever is pivoted from a pivoting initial position to the side of a pivoting completed position and the fitting and connecting of the connector housings with each other is completed. FIG. 12 is a side view which shows a state that the fitting operation lever is pivoted to the pivoting completed position and second lever engaging shafts are disengaged from cam grooves. FIG. 13 is a side view which shows a state that after the connector housings are fitted and connected with each other, the fitting operation lever is detached from the connector housings.

As shown in FIG. 1, a lever type connector 1 of the present embodiment includes a first connector housing 10, a second connector housing 20 which is fitted and connected with the first connector housing 10, and a fitting operation lever 30 which is mounted to the second connector housing 20. An arrow Z1 shown in FIG. 1 shows a direction the first connector housing 10 is fitted and mounted to the second connector housing 20. An arrow Y1 shown in the figure shows a first direction perpendicular to the arrow Z1 (a widthwise direction of the first connector housing 10).

As shown in FIG. 1, the first connector housing 10 includes a housing body 11 which includes a plurality of terminal insertion holes 11a, a pair of first lever engaging shafts (boss parts) 12, a locking part 13 and a lever temporary locking part 14.

The housing body 11 has a substantially cubical outer shape.

The pair of first lever engaging shafts 12 are columnar shafts which are protruded from a pair of outer side walls 11b of the housing body 11. The pair of outer side walls 11b are sidewalls which are opposite to each other in the arrow X1 direction in FIG. 1. The direction of the arrow X1 is a direction of the thickness of the first connector housing 10, and is a second direction perpendicular to the arrow Z1 direction and the arrow Y1 direction.

As shown in FIG. 1, the locking part 13 is provided on a side surface 11c of the housing body 11. The side surface 11c is an outer side wall surface other than the pair of outer side walls 11b described previously.

As shown in FIG. 1, the locking part 13 of present embodiment includes an elastic piece 13a which is raised up from the front end side of the side surface 11c, and extended to the back end side of the side surface 11c, and a locking protrusion 13b which is protruded from the elastic piece 13a. When the fitting and connecting of the first connector housing 10 and the second connector housing 20 is completed, the locking part 13 is engaged with the second connector housing 20 to make the connection state of the connector housings with each other to be locked.

The lever temporary locking part 14 is equipped to temporarily lock the fitting operation lever 30 which is engaged with the pair of first lever engaging shafts 12 at a pivoting initial position. In the present embodiment, the lever temporary locking part 14 is a locking groove equipped on one outer side wall 11b of the housing body 11. The lever temporary locking part 14 is provided on one outer side wall 11b at a position spaced from the first lever engaging shafts 12 in the first direction (the arrow Y1 direction in FIG. 1) perpendicular to the direction (the arrow Z2 direction in FIG. 1) the connector housings are fitted with each other.

As shown in FIGS. 1 and 2, the second connector housing 20 includes an outer box wall part (hood part) 21, a pair of second lever engaging shafts (boss parts) 22, a locked part 24 and an unlocking member 25.

The outer box wall part 21 is a rectangular pipe-like part that is formed at the front end side of the second connector housing 20, and is fitted with the circumference of the first connector housing 10. Inner side surfaces 211b of a pair of opposed side walls 211 of the outer box wall part 21 are surfaces which face the pair of outer side walls 11b of the first connector housing 10 which is fitted in the outer box wall part 21.

The pair of second lever engaging shafts 22 are columnar shafts which are protruded from the pair of inner side surfaces 211b of the outer box wall part 21. As shown in FIG. 9, when the first connector housing 10 and the second connector housing 20 are aligned to the fitting start positions, the pair of second lever engaging shafts 22 are spaced a predetermined separation distance L1 (refer to FIG. 9) from the first lever engaging shafts 12 in the direction (the arrow Z1 direction in FIG. 1) the connector housings are fitted with each other.

In the present embodiment, the first lever engaging shafts 12 and the second lever engaging shafts 22 are so arranged that in the direction perpendicular to the direction the connector housings are fitted with each other, the positions of the first lever engaging shafts 12 correspond to the positions of the second lever engaging shafts 22. Therefore, as shown in FIG. 9, the first lever engaging shafts 12 and the second lever engaging shafts 22 are placed side by side on a straight line m1 along the direction the connector housings are fitted with each other.

As shown in FIG. 11, when the fitting and connecting of the first connector housing 10 and the second connector housing 20 is completed, the locked part 24 is engaged with the locking part 13 of the first connector housing 10 to make the connection state of the connector housings with each other to be locked.

As shown in FIG. 2, the unlocking member 25 is equipped on one inner surface 211b of the outer box wall part 21. As shown in FIGS. 9 and 10, when the first connector housing 10 and the second connector housing 20 are aligned to the fitting start positions, the unlocking member 25 unlocks a temporary locked state of a fitting operation lever 30 with the lever temporary locking part 14 to be described below to make the fitting operation lever 30 pivotable.

The fitting operation lever 30 is a member by which an operating force when the operations of fitting/detaching the first connector housing 10 into/from the second connector housing 20 are performed can be reduced, and is mounted to the first connector housing 10.

As shown in FIGS. 3 to 6, the fitting operation lever 30 includes a pair of lever bodies 31, boss pivot supporting grooves 32, boss leading grooves 34, cam grooves 35 and a housing temporary locking part 36.

The pair of lever bodies 31 are thick board-like members which are arranged opposite to each other and may be inserted into the gap between the pair of outer side walls 11b of the first connector housing 10 and the pair of inner side surfaces 211b of the outer box wall part 21 of the second connector housing 20. As shown in FIGS. 4 to 6, the basic end sides of the pair of lever bodies 31 are connected by a handle part 38. The handle part 38 is a part that can be grasped when the fitting operation lever 30 is pivoted relative to the connector housings or pulled out from the connector housings.

The boss pivot supporting grooves 32 is formed at the back end inner surfaces of the pair of lever bodies 31 along the first direction (the arrow Y1 direction in FIG. 1) perpendicular to the direction the connector housings are fitted with each other. The boss pivot supporting grooves 32 are grooves with one end side open. When the fitting operation lever 30 is inserted and mounted to the first connector housing 10 so that the first lever engaging shafts 12 enter from the open ends of the boss pivot supporting grooves 32, the first lever engaging shafts 12 are engaged with the boss pivot supporting grooves 32 to pivot the fitting operation lever 30.

As shown in FIGS. 1 and 3, the boss leading grooves 34 are grooves which are formed at the lower edges on the outer surfaces of the pair of lever bodies 31 along the direction the connector housings are fitted with each other. The boss leading grooves 34 are grooves in which the second lever engaging shafts 22 are slidable. As shown in FIGS. 7 to 10, when the first connector housing 10 and the second connector housing 20 are aligned to the fitting start positions after the fitting operation lever 30 is positioned at a pivoting initial position (temporarily locked to the first connector housing 10), the boss leading grooves 34 guide the second lever engaging shafts 22 to fitting initial positions (positions as shown in FIG. 9). The fitting initial positions are the terminal ends of the boss leading grooves 34 and the beginning ends of the cam grooves 35 to be described below.

The cam grooves 35 communicate with the boss leading grooves 34 and are grooves which are formed on the outer surfaces of the pair of lever bodies 31. As shown by an arrow M1 in FIG. 9, when the fitting operation lever 30 is pivoted from the pivoting initial position to the side of the pivoting completed position, the cam grooves 35 make a force in the direction the connector housings are fitted with each other act on the second lever engaging shafts 22 which are at the fitting initial positions with the pivoting, and the connector housings are closely fitted with each other. As shown in FIG. 11, when the fitting operation lever 30 is pivoted to the fitting completed position before the pivoting completed position, the cam grooves 35 become a state that the fitting of the connector housings with each other is completed. Furthermore, when the fitting operation lever 30 is further pivoted after the connector housings are fitted with each other, and the fitting operation lever 30 is pivoted to the pivoting completed position as shown in FIG. 12, the cam grooves 35 become a state that the second lever engaging shafts 22 are separated from the cam grooves 35, and the second lever engaging shafts 22 are disengaged.

As shown in FIG. 7, when the pair of lever bodies 31 are pivoted around the first lever engaging shafts 12 which are engaged with the boss pivot supporting grooves 32 as a fulcrum to the pivoting initial position, the housing temporary locking part 36 is engaged with the lever temporary locking part 14 of the first connector housing 10, and the pair of lever bodies 31 are temporarily engaged with the first connector housing 10 at the pivoting initial position.

As shown in FIGS. 9 and 10, when the connector housings are aligned with each other to the fitting start positions, the temporary engagement of the housing temporary locking part 36 with the lever temporary locking part 14 is cancelled as the unlocking member 25 which is equipped on the second connector housing 20 makes the lever temporary locking part 14 bend in a detaching direction.

Operation steps and working effects when the connector housings of the lever type connector 1 of the present embodiment are fitted with each other are described based on FIGS. 7 to 12.

In the present embodiment, first, the fitting operation lever 30 is inserted and mounted to the first connector housing 10 so that the pair of first lever engaging shafts 12 of the first connector housing 10 are fitted into the pair of boss pivot supporting grooves 32 of the fitting operation lever 30. The fitting operation lever 30 which is mounted to the first connector housing 10 is pivoted to the side of the pivoting start position, and as shown in FIG. 7, the housing temporary locking part 36 is engaged with the lever temporary locking part 14. When the housing temporary locking part 36 is engaged with the lever temporary locking part 14, the fitting operation lever 30 is temporarily locked at the pivoting start position.

Then, the first connector housing 10 to which the fitting operation lever 30 is temporarily locked is inserted into the outer box wall part 21 of the second connector housing 20 along the direction the connector housings are fitted with each other as shown by the arrow Z2 in FIG. 7, and the first connector housing 10 and the second connector housing 20 are aligned to the fitting start positions as shown in FIG. 9.

When the first connector housing 10 and the second connector housing 20 are aligned to the fitting start positions, as shown in FIG. 9, the pair of second lever engaging shafts 22 of the second connector housing 20 are fitted in the boss leading grooves 34 of the fitting operation lever 30, and arrive at the fitting initial positions on the boss leading grooves 34.

When the first connector housing 10 and the second connector housing 20 are aligned to the fitting start positions, a detaching protrusion 36a (refer to FIG. 5) which is protruded from the housing temporary locking part 36 which is equipped on the fitting operation lever 30 rides on the unlocking member 25 of the second connector housing 20. Because the protrusion 36a rides on the unlocking member 25 as shown in FIG. 10, the housing temporary locking part 36 is bent in the direction the engagement with the lever temporary locking part 14 is cancelled. Thereby, the temporarily locking state of the fitting operation lever 30 is cancelled, and it is possible to pivot the fitting operation lever 30 to the side of the pivoting completed position.

The fitting operation lever 30 is pivoted from the state that the first connector housing 10 and the second connector housing 20 are aligned to the fitting start positions in the arrow M1 direction of FIG. 9 (the side of the pivoting completed position). As shown in FIG. 11, when the fitting operation lever 30 is pivoted to the side of the pivoting completed position, the second lever engaging shafts 22 slide in the cam grooves 35, and with the force in the fitting direction from the cam grooves 35, the connector housings are closely fitted with each other.

When the fitting operation lever 30 is pivoted to the fitting completed position before the pivoting completed position (position shown in FIG. 11), the fitting of the connector housings with each other is completed.

As the fitting operation lever 30 is further pivoted in the direction shown by the arrow M2 in FIG. 11 from the state shown in FIG. 11, the fitting operation lever 30 is pivoted to the pivoting completed position, and as shown in FIG. 12, the cam grooves 35 and the second lever engaging shafts 22 are disengaged. In this state, the fitting operation lever 30 becomes detachable from the connector housings, and when the fitting operation lever 30 is pulled out in the arrow F direction in FIG. 12, as shown in FIG. 13, the fitting operation lever 30 is detached from the connector housings.

Contrary to the detaching operation, the fitting operation lever 30 that is detached can be attached to the housings after the fitting is completed, and when the fitting operation lever 30 is pivoted in a direction reverse to the fitting direction, the fitting of the connector housings with each other can be cancelled.

The lever type connector 1 of the embodiment described above is so constructed that the connector housings are closely fitted by the pivoting operation of the fitting operation lever 30, and when the fitting operation lever 30 is further pivoted to the pivoting completed position after the fitting of the connector housings with each other is completed, the fitting operation lever 30 becomes detachable from the connector housings. Therefore, when the connector is in use, the fitting operation lever 30 can be kept detached from the connector housings.

Therefore, when the connector is in use, the weight of the fitting operation lever 30 is not added, and reduction in weight when the connector is in use can be realized.

The fitting operation lever 30 which is detached from the connector housings can be used in the fitting operations of other lever type connectors 1. Therefore, the component set of a regular lever type connector 1 only includes the first connector housing 10 and the second connector housing 20 but does not include the fitting operation lever 30, so that the cost can be reduced by reducing the number of components.

In the lever type connector 1 of the embodiment described above, if the pair of first lever engaging shafts 12 of the first connector housing 10 are engaged with the pair of boss pivot supporting grooves 32 of the fitting operation lever 30 so that the fitting operation lever 30 is pivotably connected with the first connector housing 10, when the fitting operation lever 30 on the first connector housing 10 is aligned to the pivoting initial position, as shown in FIG. 7, by engaging the housing temporary locking part 36 on the fitting operation lever 30 with the lever temporary locking part 14 on the first connector housing 10, the fitting operation lever 30 temporarily stops at the pivoting start position.

Therefore, when the first connector housing 10 and the second connector housing 20 are aligned to the fitting start positions, the position of the fitting operation lever 30 will not be unintentionally deviated from the pivoting start position, and the operation of aligning the first connector housing 10 and the second connector housing 20 becomes easy.

When the first connector housing 10 and the second connector housing 20 are aligned to the fitting start positions, the state that the fitting operation lever 30 is temporarily locked with the lever temporary locking part 14 is automatically cancelled by the unlocking member 25 which is equipped on the second connector housing 20. Therefore, after the first connector housing 10 and the second connector housing 20 are aligned to the fitting start positions, it is not necessary to cancel the temporary locking state of the fitting operation lever 30, and the pivoting operation of the fitting operation lever 30 can be performed immediately.

That is, with the lever type connector 1 of the present embodiment described above, special operations are not required to maintain or cancel the state that the fitting operation lever 30 temporarily stops at the pivoting initial position, and the operation of fitting the connector housings with each other can be easily performed.

The present invention is not restricted to the above-described embodiment, and suitable modifications, improvements and the like can be made. Moreover, the materials, shapes, dimensions, numbers, installation places, and the like of the components in the above embodiment are arbitrarily set as far as the invention can be attained, and not particularly restricted.

The features of the embodiment of the lever type connector according to the present invention described above are briefly, collectively listed in the following [1] to [2], respectively.

[1] A lever type connector (1), including:

a first connector housing (10);

a second connector housing (20) which is fitted and connected with the first connector housing (10); and

a fitting operation lever (30) which is mounted to the first connector housing (10) as a lever component to reduce an operating force when the first connector housing (10) is fitted/detached with/from the second connector housing (20), wherein

the first connector housing (10) includes:

a housing body (11) which includes a plurality of terminal insertion holes (11a);

a pair of first lever engaging shafts (12) which are protruded from a pair of outer side walls (11b) of the housing body (11), respectively; and

a locking part (13) which is provided at a side surface (11c) of the housing body (11) and is engaged with the second connector housing (20) to lock a connecting state of the connector housings with each other when the second connector housing (20) is completed to be fitted and connected with the first connector housing (10),

the second connector housing (20) includes:

an outer box wall part (21) which is fitted with a circumference of the first connector housing (10);

a pair of second lever engaging shafts (22) which are protruded respectively from a pair of inner side surfaces (211b) of the outer box wall part (21) which face the pair of outer side walls (11b) of the first connector housing (10) and which are opposed to the first lever engaging shafts (12) with a predetermined separation distance (L1) in a direction the connector housings are fitted with each other when the first connector housing (10) and the second connector housing (20) are aligned in fitting start positions; and

a locked part (24) which is engaged with the locking part (13) to lock the connecting state of the connector housings with each other when the second connector housing (20) is completed to be fitted and connected with the first connector housing (10), and

the fitting operation lever (30) includes:

a pair of lever bodies (31) which are arranged opposite to each other and to be inserted into gaps between the pair of outer side walls (11b) of the first connector housing (10) and the pair of inner side surfaces (211b) of the outer box wall part (21), respectively;

boss pivot supporting grooves (32) which are formed respectively at back end inner surfaces of the pair of lever bodies (31) along a first direction perpendicular to the direction the connector housings are fitted with each other, wherein the boss pivot supporting grooves (32) are engaged with the first lever engaging shafts (12) to pivot the fitting operation lever (30);

boss leading grooves (34) which are formed respectively at lower edges of the outer surfaces of the pair of lever bodies (31) along the direction the connector housings are fitted with each other, wherein the boss leading grooves (34) guide the second lever engaging shafts (22) to fitting initial positions when the first connector housing (10), with which the fitting operation lever (30) is positioned at a pivoting initial position, and the second connector housing (20) are aligned to the fitting start positions; and

cam grooves (35) which communicate with the boss leading grooves (34), wherein the cam grooves (35) make a force in the direction the connector housings are fitted with each other act on the second lever engaging shafts (22) which are positioned at the fitting initial positions with the pivoting so that the connector housings are closely fitted with each other when the fitting operation lever (30) is pivoted from the pivoting initial position toward a pivoting completed position, cause the connector housings to complete to be fitted with each other when the fitting operation lever (30) is pivoted to a fitting completed position before the pivoting completed position, and become disengaged from the second lever engaging shafts (22) when the fitting operation lever (30) is pivoted to the pivoting completed position, wherein

when the fitting operation lever (30) is pivoted to the pivoting completed position, the fitting operation lever (30) becomes detachable from the connector housings.

[2] The lever type connector (1) according to the above configuration [1], wherein

the first connector housing (10) includes a lever temporary locking part (14) which is provided at a side surface (11c) of the housing body (11) to temporarily lock the fitting operation lever (30) which is engaged with the pair of the first lever engaging shafts (12) at the pivoting initial position,

the second connector housing (20) includes an unlocking member (25), which, releases the temporary locking state of the fitting operation lever (30) with the lever temporary locking part (14) so that the fitting operation lever (30) is pivotable when the first connector housing (10) and the second connector housing (20) are aligned to the fitting start positions, and

the fitting operation lever (30) includes a housing temporary locking part (36) which is engaged with the lever temporary locking part (14) when the pair of lever bodies (31) are pivoted around the first lever engaging shafts (12) which are engaged with the boss pivot supporting grooves (32) as a fulcrum to the pivoting initial position so that the pair of lever bodies (31) are temporarily engaged with the first connector housing (10) at the pivoting initial position.

The present application is based upon and claims the benefit of Japanese patent application No. 2012-136045 filed on Jun. 15, 2012, the contents of which are incorporated by reference in its entirety.

### INDUSTRIAL APPLICABILITY

The fitting operation lever is detached from the connector housings, whereby reducing the cost by reducing the number of components and reducing the weight in use.

### REFERENCE SIGNS LIST

1: lever type connector

10: first connector housing

11: housing body

11a: terminal insertion hole

11b: outer side wall

12: first lever engaging shaft

13: locking part

14: lever temporary locking part

20: second connector housing

21: outer box wall part

22: second lever engaging shaft

24: locked part

30: fitting operation lever

31: lever body

32: boss pivot supporting groove

34: boss leading groove

35: cam groove

36: housing temporary locking part

211b: inner side surface

1. A lever type connector, comprising:
a first connector housing;
a second connector housing which is fitted and connected with the first connector housing; and
a fitting operation lever which is mounted to the first connector housing as a lever component to reduce an operating force when the first connector housing is fitted/detached with/from the second connector housing, wherein
the first connector housing includes:
a housing body which includes a plurality of terminal insertion holes;
a pair of first lever engaging shafts which are protruded from a pair of outer side walls of the housing body, respectively; and
a locking part which is provided at a side surface of the housing body and is engaged with the second connector housing to lock a connecting state of the connector housings with each other when the second connector housing is completed to be fitted and connected with the first connector housing,
the second connector housing includes:
an outer box wall part which is fitted with a circumference of the first connector housing;
a pair of second lever engaging shafts which are protruded respectively from a pair of inner side surfaces of the outer box wall part which face the pair of outer side walls of the first connector housing and which are opposed to the first lever engaging shafts with a predetermined separation distance in a direction the connector housings are fitted with each other when the first connector housing and the second connector housing are aligned in fitting start positions; and
a locked part which is engaged with the locking part to lock the connecting state of the connector housings with each other when the second connector housing is completed to be fitted and connected with the first connector housing, and
the fitting operation lever includes:
a pair of lever bodies which are arranged opposite to each other and to be inserted into gaps between the pair of outer side walls of the first connector housing and the pair of inner side surfaces of the outer box wall part, respectively;
boss pivot supporting grooves which are formed respectively at back end inner surfaces of the pair of lever bodies along a first direction perpendicular to the direction the connector housings are fitted with each other, wherein the boss pivot supporting grooves are engaged with the first lever engaging shafts to pivot the fitting operation lever;
boss leading grooves which are formed respectively at lower edges of the outer surfaces of the pair of lever bodies along the direction the connector housings are fitted with each other, wherein the boss leading grooves guide the second lever engaging shafts to fitting initial positions when the first connector housing, with which the fitting operation lever is positioned at a pivoting initial position, and the second connector housing are aligned to the fitting start positions; and
cam grooves which communicate with the boss leading grooves, wherein the cam grooves make a force in the direction the connector housings are fitted with each other act on the second lever engaging shafts which are positioned at the fitting initial positions with the pivoting so that the connector housings are closely fitted with each other when the fitting operation lever is pivoted from the pivoting initial position toward a pivoting completed position, cause the connector housings to complete to be fitted with each other when the fitting operation lever is pivoted to a fitting completed position before the pivoting completed position, and become disengaged from the second lever engaging shafts when the fitting operation lever is pivoted to the pivoting completed position, wherein
when the fitting operation lever is pivoted to the pivoting completed position, the fitting operation lever becomes detachable from the connector housings.

2. The lever type connector according to claim 1, wherein
the first connector housing includes a lever temporary locking part which is provided at a side surface of the housing body to temporarily lock the fitting operation lever which is engaged with the pair of the first lever engaging shafts at the pivoting initial position,
the second connector housing includes an unlocking member, which, releases the temporary locking state of the fitting operation lever with the lever temporary locking part so that the fitting operation lever is pivotable when the first connector housing and the second connector housing are aligned to the fitting start positions, and
the fitting operation lever includes a housing temporary locking part which is engaged with the lever temporary locking part when the pair of lever bodies are pivoted around the first lever engaging shafts which are engaged with the boss pivot supporting grooves as a fulcrum to the pivoting initial position so that the pair of lever bodies are temporarily engaged with the first connector housing at the pivoting initial position.
